(19) United States
(12) Patent Application Publication
(10) Pub. No.: US 2009/0234042 A1
(43) Pub. Date: Sep. 17, 2009

(54) TRANSPARENT BLENDS OF POLYPROPYLENE CARBONATE

(75) Inventor: Gerrit Luinstra, Mannheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (JP)

(21) Appl. No.: 12/298,251

(22) PCT Filed: Apr. 18, 2007
(86) PCT No.: PCT/EP07/53759

§ 371 Date: Oct. 23, 2008

(30) Foreign Application Priority Data
Apr. 27, 2006 (EP) 06113201.5
Mar. 27, 2007 (EP) 07104484.6

(51) Int. Cl. C08L 69/00

(52) U.S. Cl. 523/105; 524/502

(57) ABSTRACT

This invention is directed to transparent blends of polypropylene carbonate with poly lactide and/or polyhydroxyalkanoates, to a process for the preparation of said blends as well as the use of said blends.

This invention is directed to transparent blends of polypropylene carbonate with polylactide and/or polyhydroxyalkanoates, to a process for the preparation of said blends as well as the use of said blends.

High molecular weight Polypropylencarbonate (PPC) is a thermoplastic, amorphous (transparent) material with a glass temperature in the range of 25 to 45° C. Latter is depending on the carbonate linkage percentage and the presence and amount of plasticizers like cyclic propylene carbonate, which is a typical thermal decomposition product and/or side product of the synthesis. This means that the softening point of the polypropylene carbonate is usually at room or body temperature. This is disadvantageous for some applications in for example packaging sector: container prepared from polypropylene carbonate through injection or blow moulding will loose their shape inside a closed car on a sunny day in the sun. In addition, granulate of polypropylene carbonate tend to clog together at ambient temperature. As a consequence, the transport in form of the usual pellets from manufacturer to customers may result in a sticky block, which cannot be handled by standard equipment. As a result additional costs arise, for example for necessary milling or melting equipment.

The above situation is unfavourable for the application of polypropylene carbonate as a thermoplastic material. An increase in the glass temperature and young modulus of the thermoplastic material would improve the properties with respect to application purposes and processing. The glass temperature of a polymeric material can for example be increased through the formation of blends with other materials including with other polymers.

Blends of polypropylene carbonate are known, however, they are all non-transparent as the result of a non-compatibility. This is expected, since different polymers tend to be immiscible. This has been explained by for example the differences in solubility parameter [Van Krevelen, Chapter 7.]: from a theoretical point of view, the solubility parameter of two components have to be identical within 0.1 (J/cm³)^{1/2}. This is rarely the case, and it is thus to be expected that polymers in general are immiscible as is observed for the opaque blends of polypropylene carbonate with SAN, PS, PP, PMMA (see examples). E.g. U.S. Pat. No. 4,912,149 describes non-transparent blends of polypropylene carbonate and PVC.

Blends of polyhydroxybutyrate (PHB) or polyhydroxybutyrate-covalerate (PHBV) and polypropylene carbonate are reported in U.S. Pat. No. 6,576,694. The reported blends are, however, non transparent as expected on account of the different solubility parameter as explained above. The reported blends consist of 30-70 parts of polypropylene carbonate respectively 70-30 parts of polyhydroxyalkanoates. Blends like this were also reported in for example Gaodeng Xuexiao Huaxue Xuebao 2004, 25, 1145 (CA: 141:350588) or Macromolecular symposia 2004, 210, 241, J. Appl. Chem. 2004, 92, 2514-21 or ibid 2003, 90, 4054-60. All these reports are concerned about melting behavior of the PHB, but did not find a transparent PPC based material.

However, there are good reasons for the use of transparent materials. They provide appealing qualities in form of attractive design options, direct visual contact to packaged goods (e.g. vegetables, fruits, meat) or to uniformly dying at low effort and costs. We thus set out to find blend components for polypropylene carbonate to improve the glass temperature and/or young modulus and to keep the excellent transparency in the resulting materials.

Surprisingly, it is found that a transparent polypropylene carbonate (PPC) blend is formed by blending it with PLA (polylactid acid) independently of the ratio of the two components (PLA and PPC) in the blend.

Yet in another embodiment of this invention, transparent blends of polypropylene carbonate and PHB(V) are prepared, wherein the maximum amount of PHB(V) is not exceeding 15 parts by weight of a total of 100 in the sum with polypropylene carbonate. This is very surprising and favorable for the properties of the blend.

In addition, the blends according to the invention have a higher glass temperature than the starting material PPC. Furthermore, we found that the elastic modulus of said blends could be improved without losing the transparency. The resulting blends can be processed using standard methods including injection and blow moulding and are suitable for applications in packaging, play (toys, recreational), hygiene (household) and medical, construction, sporting and art sector.

### Details

The transparent blends of PPC comprise the following components wherein the sum of the parts of PPC and PLA or PHB are 100 parts by weight

a) a first embodiment:
(i) 1-99 parts by weight of polypropylencarbonate having a molecular weight (Mn) between 30,000 and 5,000,000 Da,
(ii) 99-1 parts by weight of polylactid,
(iii) 0.1-25 parts of an additional component that is known to function as an antioxidant, a flame retardant, a filler, a (metal) complexing agent, a plasticizer or processing aid, pigment, dye, brightener and/or antistatic agent;

The first embodiment comprises preferably:
(i) 10-90 parts by weight of polypropylencarbonate having a molecular weight (Mn) between 30,000 and 50,000 Da,
(ii) 90-10 parts by weight of polylactid,
(iii) 0.5-15 parts of an additional component that is known to function as an antioxidant, a flame retardant, a filler, a (metal) complexing agent, a plasticizer or processing aid, pigment, dye, brightener and/or antistatic agent;
   or
   b) a second embodiment:
(i) 85-99 parts by weight of polypropylencarbonate having a molecular weight (Mn) between 30,000 and 5,000,000 Da,
(ii) 15-1 parts by weight of polyhydroxyalkanoate,
(iii) 0.1-25 parts of an additional component that is known to function as an antioxidant, a flame retardant, a filler, a (metal) complexing agent, a plasticizer or processing aid, pigment, dye, brightener or antistatic agent;

The second embodiment comprises preferably:
(i) 90-98 parts by weight of polypropylencarbonate,
(ii) 10-2 parts by weight of polyhydroxybutyrate,
(iii) 0.5-15 parts of an additional component that is known to function as an an antioxidant, a flame retardant, a filler, a (metal) complexing agent, a plasticizer or processing aid, pigment, dye, brightener or antistatic agent;
   or
   c) a third embodiment comprising mixtures of the first and second embodiments:
(i) 5-97 parts by weight of polypropylencarbonate,
(iia) 80-2 parts by weight of polylactid,
(iib) 15-1 parts by weight of polyhydroxyalkanoate,
(iii) 0.5-15 parts of an additional component that is known to function as an antioxidant, a flame retardant, a filler, a (metal) complexing agent, a plasticizer or processing aid, pigment, dye, brightener or antistatic agent;

The third embodiment comprises preferably:
(i) 30-97 parts by weight of polypropylencarbonate,
(iia) 60-2 parts by weight of polylactid,
(iib) 10-1 parts by weight of polyhydroxybutyrate,
(iii) 0.5-15 parts of an additional component that is known to function as an antioxidant, a flame retardant, a filler, a (metal) complexing agent, a plasticizer or processing aid, pigment, dye, brightener or antistatic agent;
   or
   d) a fourth embodiment preferably:
(i) 20-80 parts by weight of polypropylencarbonate,
(ii) 60-15 parts by weight of polylactid,
(iii) 0.5-15 parts of an additional component that is known to function as an antioxidant, a flame retardant, a filler, a (metal) complexing agent, a plasticizer or processing aid, pigment, dye, brightener or antistatic agent,
(iv) 20-5 parts by weight of a biodegradable aliphatic or aliphatic/aromatic polyester.

Polypropylene carbonate (PPC) useful in this invention is the resulting copolymer of the copolymerization of carbon dioxide and propylene oxide. The polymer may contain both ether and carbonate linkages in the main chain. The percentage of carbonate linkages is dependent on the reaction conditions and for example the nature of the catalyst. Preferably the polymer comprises more than an 85 and mostly preferred more than a 90 percentage of carbonate linkages of all linkages between former PO monomer. Several catalyst systems are known that catalyze the copolymerization; for example zinc glutarate as described in U.S. Pat. No. 4,789,727. Furthermore, PPC can be prepared according to Soga et al., Polymer Journal, 1981, 13, 407-10. A particularly preferred process in preparing high-molecular weight PPC is disclosed in WO-A 06/061237. Mn of material obtained by the above process is about 70-90,000; Mw is 300,000 Da; the ether to carbonate linkage ratio is 7 to 93. The polymer is also commercially available e.g. from empower materials or Aldrich. This material is also useful in this invention. The PPC may have been treated with several agents to improve its properties, for example with anhydrides like MSA, acetic anhydride, isocyanates or epoxides The molecular weights of the PPC are generally in the range of number average Mn between 30,000 and 5,000,000 Da, preferably between 35,000 and 250,000 Da, most preferably between 40,000 and 150,000 Da. PPC of lower molecular weight than about Mn=25,000 Da suffers from a low glass temperature Tg (<25° C.) and has a too low Young's modulus (Iso 527-2, DIN 53455: <400 MPa) and a break stress lower than 10 MPa (and is not very suitable in this invention on account of the low entanglement density. The ratio of number average and weight average molecular weight lies between preferably 1 and 100, most preferably between 2 and 10. The polypropylene carbonate may also contain up to 1% carbamate or urea entities.

Polylactide (PLA) is semi-amorphous with a Tg of around 60° C. and useful in this invention. PLA is a commercial available polymer that is based on substantially enantiomeric pure lactic acid (see Nature Works® von Cargill Dow). Lactic acid is preferentially obtained from an agricultural biological source like sugar or starch in a fermentative process. Generally speaking any PLA with a Tg larger than 40° C. is useful in this invention. The molecular weights are preferably in the range of number average Mn between 5,000 and 5,000,000 Da, preferably between 10,000 and 250,000 Da, most preferably between 25,000 and 150,000 Da. PLA may have been treated prior to its application in this invention with agents to improve its properties, e.g. like those mentioned by Sinclair R. G. in Pure & Appl. Chem. 1996, A33, 585-97.

Polyhydroxyalkanoates embrace preferably polyhydroxybutyrate (PHB(V)), particularly preferred poly-3-hydroxybutyrate (PHB) and polyhydroxybutyrate covaleriate (PHBV). Generally speaking, any crystalline PHB(V) is useful in this invention when it improves the young modulus of PPC component blend. PHB(V) may be obtained commercially from e.g. Aldrich. Also copolymers of 3-hydroxybutyric acid and other hydroxyacids may be used in this invention. A special case of the latter is the copolymer of 3-hydroxybutyric acid (see Biocycle® of PHB Industries) and 3-hydroxy valeric acid, with a maximum of 30% of the latter (see Enmat® of Tianan). 4-Hydroxybutyrate as available by Metabolix is especially preferred.

Aliphatic or aromatic-aliphatic polyesters can be used as bio-degradable polyesters (component (iv)). Preferred elements of the polyesters are:
aliphatic dicarbonic acids as succinic, adipic or sebacinic acid, or esters or mixtures thereof,
occasionally aromatic dicarbonic acids as terephthalic acid or esters thereof and
diols as 1,4-butanediol or 1,3-propanediol.

Ecoflex® (BASF Aktiengesellschaft), Eastar Bio® and Origo Bi® (Novamont), Bionolle® (Showa Highpolymers) are preferred bio-degradable polyesters.

The above polymers may be applied in form of pellets or powder or be molten prior to blending. The pellets have preferable dimensions of 0.1 to 20 mm, most preferably between 2 and 7 mm. They may have any shape. The powder is preferably in the range of 1-1000 μm.

The blends of the invention may contain any antioxidant known in the art such as but not limited to hindered phenols, like Irganox® 1010 obtainable from Ciba Speciality Chemicals or Uvinul® obtainable from BASF Aktiengesellschaft. The amount of the anti oxidant(s) used in this invention may be about 0.1-2 parts by weight, preferably not exceeding 1% by weight relative to the blend polymeric components.

The blends of the invention may contain any plasticizer, as for example phthalates, triethyleneglycol diacetate, citrates, terephthalic esters, adipinic ester, succinic ester, malonic ester, maleic ester, etc.

Using plasticizers the continuous phase of PPC can be extended to a lower PPC content in the blend.

The blends of the invention may contain any filler such as caolin, calcium carbonate, talcum, silica, cellulose, crayon or starch. Preferred fillers are calcium carbonate and starch.

The blends of the invention may contain any stabilizer in form of an anhydride, diepoxide such as preferred glycidyl-methacrylate (see Joncryl® ADR 4368 from Johnson Polymer) or epoxidized oils such as Merginat® ESBO from Hobum, Hamburg or Edenol® B316 vfrom Cognis, Düsseldorf), caprolacton and/or diisocyanates. The blends also may comprise additional components that improve its properties e.g. thermal stability, biodegrability, resistance to (bio)degradation, burning behavior or processing aids. Also additives like pigments, dyes, brighteners, antistatic agents (such as ten-sides) and the like may be added.

Blends of polypropylene carbonate can be obtained by any of several of known methods, for example by combining solutions of the blend components or by roller mixing or by compounding in an extruder or kneader and alike. In a preferably embodiment, the extrusion and pelletization of the blends are performed in an extruder with a single or twin screw. In yet another preferred embodiment, the blends are prepared by roller mixing of the components. In these cases, the material is molten in the temperature range of 150-230° C., preferably in the range of 170-200° C.

In another preferred embodiment, the blend is prepared from a solvent. Any solvent dissolving at least one of the components may be used; preferably a solvent is used that dissolves both components. Preferred solvents include dichloromethane, trichloromethane, tetrahydrofurane, N-methylpyrrolidon, dimethylsulfoxide, esters like ethyl acetate, ketones like acetone or methylethylketone. Most preferred are volatile solvents like trichloromethane and tetrahydrofurane.

Blends may be processed into a number of forms e.g. for transport or processing. Most preferred the blends are prepared by compounding on an extruder and the resulting melt subsequently processed into a strand, which is subsequently cut into pellets or milled into a powder.

In order to evaluate the properties of the blends, they were processed into sheets of 1 mm thickness and 6·6 cm² area. All blends were transparent by the eye, e.g. by looking through against a brighter light or when covering a flat underground. This is highly surprising since blends of high molecular weight polymers are generally opaque as the result of breaking of light at the phase boundaries of the insoluble dispersed components. A transparent blend may result if the comprising polymers are fully miscible, as it has been observed for example in blends of polystyrene and polyphenylether. This is not the case here, as follows from the fact that the blends exhibit glass temperatures close to those of the components. We find that the blends of PLA and PPC are transparent because of matching refractive indices (1.46). Thus, although phase boundaries are present in the blend, light is not scattered. This is also highly surprising.

In case of PHB, a crystalline part was obtained with a melt temperature in the range 150-200° C. with a crystallization temperature in the range of 0 to 80° C., preferable in the range of 20-60° C., most preferable in the range of 40-50° C.

Pellets of the blends or blends prepared in situ may be processed into sheeting, containers or other forms also as component of a 2K processing set up using injection or blow moulding or by rotary molding. Also techniques like deep drawing or compression molding could be used.

The blends according to the invention comprises blends of polypropylene carbonate and PLA or blends of polypropylene carbonate and 1 to 15 parts by weight of PHB(V). These blends are transparent and have improved properties compared to PPC with respect to glass temperature and/or young modulus. Accordingly said blends can be used in many new applications such as food packaging in form of sheeting or containers for solids or liquids like beverages, or toys as an alternative in applications typical for (plasticized) PVC. Also in construction purposes e.g. as an interlayer in between window panels. A further advantage of commercial relevance is the fact that the blends and their fragments are hydrolytically- and/or bio-degradable by natural occurring microorganisms.

Foams of the blends according to the invention can be formed as shown in EP 07102477.2 and EP 07102497.0; “foam extrusion—principles and practice”, Shau-Tarng Lee, 376 pages, CRC Press, 2000; “thermoplastic foam extrusion”, James Thorne, Carl Hanser, 2006. The foams have the following advantages:
Translucent, highly light-transmissive foam structure
Soft touch—even coextruded
Biodegradibility in compost plant
CO₂-trap by the use of PPC
Useful for food grade applications
Highly UV-resistant
Suitable for deep-drawing.

Shortcomings for some applications might be the low temperature resistance and the low hydrolytic stability.

The foams can be used as foam trays for meat, fish, fruits and vegetables; clampshells for fast food; protective films for e.g. products with sensitive surfaces as consumer goods, cars or electronic goods, e.g. television sets, radios, mp3 players and cell phones; separation layers for packaging; foam trays ant inserts for fruit or vegetable crates; foamed cleaning cloth or foamed beads for fish boxes

The blends according to the invention can be perfectly used for transparent, rigid or semi-rigid packaging or for displays. Relevant production processes are disclosed in: “Polymer Extrusion”, Chris Rauwendaal, Carl Hanser, 1986; “Thermoforming”, James Thorne, Carl Hanser, 1986; “Einführung in die Kunststoffverarbeitung”, Walter Michaeli, Carl Hanser, 2006; “Handbuch Spritzgieβen”, Friedrich Johannaber, W. Michaeli, Carl Hanser, 2004; “Blow Molding Handbook”, Dominik V. Rosato et al., Carl Hanser, 2004; “Kunststoff Maschinenführer”, Friedrich Johannaber, Carl Hanser, 2004.

In the field of extrusion of films and thermoforming (inline or off-line) the following applications are particularly interesting: cups, lids, trays and straws for catering or take away food; transparent packaging for dairy products; transparent, semi-rigid packaging for sausage including cold cut, meat, cheese, fish and vegetarian food; food trays; blister-packs for pills, medical products and non-food goods.

With extrusion-blow-molding e.g. bottles for beverages, cosmetics, detergents, crop protection agents or chemicals are available.

With profile extrusion hygiene products like tooth brushes, combs, cotton buds, lipstick, brushes; long lines for the fishery industry; infusion tubes or raffia can be produced.

Injection blow molding of the blends according to the invention leads inter alia to bottles for beverages (as mineral water or soft drinks), cosmetics, detergents, crop protection agents or chemicals.

Film extrusion is disclosed e.g. in “Kunststoff-Folien Herstellung-Eigenschaften-Anwendung”, Joachim Nentwig, Carl Hanser, 2001. By this process the blends according to the invention are transformed to: films for hygiene applications; e.g. back sheets for nappies, lady care products; bags for fruits and vegetables; carrier bags, shoppers; compost bags; waste bags; peelable lidding film—transparent or opaque —; weldable lidding films—transparent or opaque —; shrink film, sausage casings, salad films, stretch film (cling film) for fruits and vegetables, meat and fish; stretch film for pallet wrap; films for nets.

Due to the excellent barrier properties the blends according to the invention are predestinated for packing of meat, poultry, meat products, processed meat, sausages; sea food, fish, crab meat; cheese, processed cheese; desserts; pastry, e.g. with meat, fish, poultry, tomato; bread, biscuits, bakery products; fruits, fruit juices, vegetables, tomato paste, salads; pet food; pharmaceuticals; coffee, coffee-like products; milk- or chocolate powder, coffee creamers, baby food; dehydrated food; jams and jellies; spreads, chocolate paste; menus. For more detailed information see the reference “Food Processing Handbook”, James G. Brennan, Wiley-VCH, 2005.

A detailed review regarding packaging technology is shown in references: “Food Packaging Technology”, Richard Coles, Derek McDowell, Mark; Blackwell Publisching, CNC Press, 2003 and “Wursthüllen Kunstdarm-Herstellung-Eigenschaften, Anwendung”, Gerhard Effenberger, Holzmann Verlag, 1991. Starting from the blends according to the invention e.g. modified atmosphere packaging, transparent barrier films, boilable and sterilisable films and non-metal barrier films are available.

The blends according to the invention are also useful for the following applications: e.g. bowls, beakers, utensils, washing machines, cooking machines, (garden) furniture, television sets, radios, mp3 players, cell phones, children's toys, like for example playing balls, sand molds, shovels, rakes, pawns, dices, rattlers, toy cars, three wheelers, bicycles, and also equipment used in table-top games like balls and protective wear.

Because of the design options the blends are useful for hygiene products like tooth brushes, combs, Q tips, lipstick or brushes, extruded piping for garden hoses 2 and 3-dimensional works of art etc.

Due to the interesting haptic behavior the blends according to the invention can be used in footwear, e.g. soles, in lays, in lays for ski boots, knee pads, epaulettes and in lays in bras or other sport, cosmetic or medical products.

The blends may also be formed into fibers e.g. by a spinning process for the preparation of garments, bet sheets or blankets.

### EXAMPLES

In the examples the following materials were used:

Polypropylene carbonate was obtained by copolymerizing PO and CO₂ at 80° C. in a 1:2 mixture with toluene and using zinc glutarate (1 kg catalyst was used for the preparation of 20-50 kg polymer) as catalyst at 50 bar pressure in a 100 L reactor (see also WO 06/061237). The resulting slurry was diluted with ethyl acetate and extracted with water containing over 5% acetic acid. PPC was isolated from the organic phase with the aid of an extruder to give clear granulate with a carbonate linkages content of 93-95% (by NMR). Mn=70.000 Da, Mw=320.000 Da, Tg=31-33° C. In another batch using 1 kg of zinc glutarate to prepare 10 kg of PPC, a material with Mn=42,000 and Mw=200,000 Da was obtained.

Polypropylene carbonate (PPC) could also be obtained commercially from empower materials with a carbonate content of about 98, Mw of 250.000 Da and a glass temperature of 40° C.

PLA was obtained from Cargill Dow (Nature® Works 4041 D);

PHB was obtained from PHB Industries (Biocycle®1000).

Mechanics (elongation at break) were determined according to ISO 527-2.

### Preparation of PPC/PLA Blends.

### Blend Preparation Using Solvents

### Example 1

PPC (20 g) was dissolved in 80 g of chloroform and mixed with solution of PLA (20 g) in 80 g of chloroform. The resulting clear solution was evaporated to dryness in a vacuum. The blend was isolated as a transparent material with few gas bubbles. After cutting, the material was pressed into a sheet of 1 mm thickness at 180° C. using pressure of 200 bar, pressing time 8 min. It is transparent by the eye. Highest Tg was determined at 50° C.

### Example 2 to 4

By the same procedure blends with a weight percentage of 70% (example 2), 40% (example 3) and 20% (example 4) PPC were obtained. All blends were transparent by visual inspection.

GPC measurements of blend of examples 1 to 4 showed that no breakdown of molecular weight had taken place, rather a superposition of the individual components was obtained (Mn=70 to 90 kDa, Mw=300 kDa). Highest Tg was found at 50° C.

### Comparison Example 5 and 6

These examples show that blends of polypropylene carbonate with polymers of comparable solubility parameter are not transparent.

In example 5, 20 g of PS was dissolved in 80 g of chloroform and mixed with 20 g of polypropylene carbonate dissolved in 80 g of chloroform.

In example 6, 20 g of Ecoflex® from BASF Aktiengesellschaft (a copolyester of adipinic acid, 1,4-butanediol and terephthalic acid) was dissolved in 80 g of chloroform and mixed with 20 g of PPC dissolved in 80 g of chloroform. Both the mixed solutions of example 5 and 6 were not fully clear. The dried sheets were fully intransparent as well as the compression molded sheets of 1 mm thickness thereof. DSC measurements showed glass transitions coincident with those of the components (PS: 101° C., Ecoflex −39° C.).

### Blend Preparation by Roller Mixing

### Examples 7 and 8

Rolls were heated to 180° C., roller mixing was performed for at least 8 minutes or until individual phases were no longer observable (max of 15 min). A total of 101 g was used consisting of 1% Irganox 1010 stabilizer and 60 g PPC and 40 g PLA in example 7 and 1% Irganox 1010 stabilizer and 40% PPC and 60% PLA in example 8. In both cases, a clear sheet results that is tough and not tacky to metal, wood and skin. DSC measurements showed that a mixing of phases was not measurable as two glass transition at 35° C. and 59° C. are found, almost identical to those of PPC PLA, respectively. The sheets were cut into smaller pieces (±50-100 mm²) and subjected to compression molding. Transparent sheets of 1 mm thickness were obtained. These were colorless, tough and stiff and not tacky.

### Blend Preparation by Compounding in an Extruder

### Examples 9 to 11

Blends of PPC and PLA were prepared by compounding in an extruder of the mini molder type with return flow. In a typical experiment, 11 g of polymer were used. The processing temperature was set at 190° C. (180° C. at the entrance). The blend was prepared using the mini molder during 3 to 5 minutes. The hot melt was injection molded into a dumbbell with 10-15 bar of pressure at 50° C. Latter were easily demolded and subjected to mechanical measurements.

Experiment 9 consisted of 75% polypropylene carbonate, 25% (by weight) PLA, Experiment 10 was a 50:50 mixture of polypropylene carbonate/PLA by weight and experiment 11 was a 25% polypropylene carbonate and 75% PLA. All blends were transparent and colorless. The results show, that the modulus increases and favorably for the applications listed above.

| | | | | stress at |
|---|---|---|---|---|
| | PPC by | PLA by | | break |
| Experiment | weight % | weight % | Emod (MPa)* | (MPa)** |
| 9 | 75 | 25 | n.d. | 14 |
| 10 | 50 | 50 | 2000 | 38 |
| 11 | 25 | 75 | 2700 | 50 |
| | 100 | | 600 | 6 |

*according to ISO 527-2,
**DIN 53455)

The mechanical properties were measured: the elastic modulus had increased from about 600 to 3500 MPa, and could be adjusted with the composition. Furthermore, the resistance to break was significantly increased. Several glass transitions Tg of the blends were found, the highest decisive for the Emod was found at 58° C.

### Preparation of PPC/PHB Blends

### Comparison Experiment 12

A blend using 20% of PHB and 80% of PPC was prepared using roller mixing as described in example 7. Mixing time was 8 minutes and temperature was 180° C. The resulting sheet was easily removed and nontransparent after visual inspection.

### Example 13 to 15

As described in experiment 12, blends of PPC and a lower content of PHB were prepared using roller mixing. In all experiments, Irganox 1010, 1% by weight based on the sum of weights of PPC and PHB was added. The next table shows the results.

| | Polypropylene | | |
|---|---|---|---|
| | carbonate | PHB | |
| Experiment | (weight %) | (weight %) | DSC |
| 13 | 90 | 10 | Tm 171, Tg 0° C., |
| | | | Tg 32° C. |
| 14 | 95 | 5 | Tm 183/179, Tg −4° C., |
| | | | Tg 30° C. |
| 15 | 98 | 2 | nd |

These data show, that two phases are present, one has the characteristics of PHB, increasing the elastic modulus of the blend on account of the crystalits with Tm=170-180° C., and PPC basically its parent form.

### Example 16 to 18

As described under example 9, a blend was prepared from polypropylene carbonate and PHB, with the addition of 1% of Irganox 1010 by weight based upon the total weight of the polymers. The resulting melt was used for injection molding to prepare dumbbells. These were evaluated. The material properties are listed in the below table.

| | Polypropylene | | | |
|---|---|---|---|---|
| | carbonate | PHB | Emod* | Stress at |
| Experiment | (weight %) | (weight %) | (MPa) | break** |
| 16 | 90 | 10 | 1080 | 37 |
| 17 | 95 | 5 | 870 | 29 |
| 18 | 98 | 2 | nd | 5 |

*(Measured according to ISO 527-2,
**DIN 53455)

The Young modulus increased from 600 to about 1000 MPa. The composition allows one to adjust the modulus.

1-12. (canceled)

13. A transparent blend comprising
i) 1 to 99 parts by weight of polypropylencarbonate having a number molecular weight (Mn) of from 30,000 to 5,000,000 Da and a Young's modulus of at least 400 Mpascal;
ii) 99 to 1 parts by weight of polylactid; and
iii) 0.1 to 25 parts of an antioxidant, a flame retardant, a filler, a (metal) complexing agent, a plasticizer or processing aid, a pigments, a dye, a brightener, an antistatic agent, or combinations thereof;
wherein the sum of the parts of said polypropylencarbonate and said polylactid is 100 parts by weight.

14. A transparent blend comprising
i) 85 to 99 parts by weight of polypropylencarbonate having a number molecular weight (Mn) of from 30,000 to 5,000,000 Da and a Young's modulus of at least 400 Mpascal;
ii) 15 to 1 parts by weight of polyhydroxyalkanoates;
iii) 0.1 to 25 parts of an antioxidant, a flame retardant, a filler, a (metal) complexing agent, a plasticizer or processing aid, a pigments, a dye, a brightener, an antistatic agent, or combinations thereof;
wherein the sum of the parts of said polypropylencarbonate and said polylactid is 100 parts by weight.

15. The transparent blend of claim 13, wherein said polypropylencarbonate has a number molecular weight Mn of from 35,000 to 250,000 g/mol Da.

16. The transparent blend of claim 13, wherein said polypropylencarbonate has a break stress of at least 10 MPascal.

17. The transparent blend of claim 13, wherein the C₂-units of said polypropylencarbonate are from 90% to 100% linked via a carbonate group.

18. The transparent blend of claim 13, wherein said transparent blend comprises a stabilizer, a plasticizer, and/or a filler

19. A transparent terblend comprising
(i) 30 to 97 parts by weight of polypropylencarbonate;
(iia) 60 to 2 parts by weight of polylactid;
(iib) 10 to 1 parts by weight of polyhydroxybutyrate; and
(iii) 0.5 to 15 parts of an antioxidant, a flame retardant, a filler, a (metal) complexing agent, a plasticizer or processing aid, a pigments, a dye, a brightener, an antistatic agent, or combinations thereof
wherein the sum of the parts of said polypropylencarbonate, said polylactid, and said polyhydroxybutyrate is 100 parts by weight.

20. The transparent blend of claim 13, wherein said transparent blend is prepared using an extruder, by kneader or roller mixing, by compression, or by extrusion blow moulding.

21. A slow release matrix for use in agricultural and medical applications comprising the transparent blend of claim 13.

22. A packaging, a toy, a sporting good, a hygiene product, a household product, a medical product, a cosmetic product, an electronic appliance, an electric appliance, or an optical device comprising the transparent blend of claim 13.

23. A barrier packaging or a semi-rigid packaging comprising the transparent blend of claim 13.
